(19) United States
(12) Patent Application Publication
(10) Pub. No.: US 2025/0086627 A1
(43) Pub. Date: Mar. 13, 2025

(54) SYSTEMS AND METHODS FOR NEAR REAL TIME BLOCKCHAIN BASED PAYABLES VERSUS RECEIVABLES RECONCILIATION

(71) Applicant: JPMORGAN CHASE BANK, N.A., New York, NY (US)

(72) Inventors: Niti SHAH, Mumbai (IN); Jitesh PARMAR, Mumbai (IN); Alistair BARETTO, Thane (IN); Shailesh PANDEY, Mumbai (IN)

(21) Appl. No.: 18/492,515

(22) Filed: Oct. 23, 2023

(30) Foreign Application Priority Data
Sep. 8, 2023 (IN) 202311060572

(51) Int. Cl. G06Q 20/40; G06Q 20/38

(52) U.S. Cl. CPC G06Q 20/401; G06Q 20/389

(57) ABSTRACT

A method may include a computer program executed by a financial institution backend: (1) receiving payables data for a plurality of transactions from a merchant, wherein each of the plurality of transactions in the payables data comprises a transaction identifier, a merchant identifier, a payable transaction amount, and a payables currency; (2) writing the payables data to a blockchain; (3) sending the payables data to a payment brand, wherein a payment brand computer program is configured to generate receivables data for the plurality of transactions, and the receivables data for each of the plurality of transactions comprises the transaction identifier, a receivable transaction amount, and a receivable currency; (4) receiving the receivables data; and (5) writing the receivables data to a blockchain, wherein a smart contract on the blockchain is configured to reconcile the transactions in the payables data with the transactions in the receivables data.

### RELATED APPLICATIONS

This application claims priority to, and the benefit of, Indian Patent Application No. 202311060572, filed Sep. 8, 2023, the disclosure of which is hereby incorporated, by reference, in its entirety.

### BACKGROUND OF THE INVENTION

### 1. Field of the Invention

Embodiments are generally directed to systems and methods for near real time blockchain based payables versus receivables reconciliation.

### 2. Description of the Related Art

In payments technology, the reconciliation between receivables and payables happens 24 hours after receiving data from payment brands (e.g., Visa, Mastercard, etc.) and merchants. This leads to a delay in confirmation of settlement for actual money movement, as well as in detecting reconciliation issues.

### SUMMARY OF THE INVENTION

Systems and methods for near real time blockchain based payables versus receivables reconciliation are disclosed. In one embodiment, a method may include: (1) receiving, at a computer program executed by a financial institution backend, payables data for a plurality of transactions from a merchant, wherein each of the plurality of transactions in the payables data may include a transaction identifier, a merchant identifier, a payable transaction amount, and a payables currency; (2) writing, by the computer program, the payables data to a blockchain; (3) sending, by the computer program, the payables data to a payment brand, wherein a payment brand computer program may be configured to generate receivables data for the plurality of transactions, and the receivables data for each of the plurality of transactions may include the transaction identifier, a receivable transaction amount, and a receivable currency; (4) receiving, by the computer program, the receivables data; and (5) writing, by the computer program, the receivables data to a blockchain, wherein a smart contract on the blockchain may be configured to reconcile the transactions in the payables data with the transactions in the receivables data.

In one embodiment, the method may also include reformatting, by the computer program, the payables data before writing the payables data to the blockchain.

In one embodiment, the computer program writes the payables data to the blockchain as groups of transactions based on the payment brand associated with the transaction.

In one embodiment, the computer program sends the payables data to the payment brand in an agreed-upon format.

In one embodiment, the payment brand may be configured to send the payables data to an issuer bank for confirmation.

In one embodiment, the method may also include reformatting, by the computer program, the receivables data before writing the receivables data to the blockchain.

In one embodiment, the smart contract may be configured to monitor the blockchain for the payables data and the receivables data.

In one embodiment, the smart contract may be configured to identify unmatched transactions.

In one embodiment, the unmatched transactions are ingested into a machine learning engine that predicts a corrective action for the unmatched transactions.

In one embodiment, the corrective action may include sending the unmatched transactions to the payment brand for correction.

In one embodiment, the machine learning engine may be trained with historical transaction data and historical corrective actions.

In one embodiment, the machine learning engine may be further trained with the corrective actions for the unmatched transactions.

In one embodiment, the smart contract may be configured to provide a status of matched and unmatched transactions to the merchant.

### BRIEF DESCRIPTION OF THE DRAWINGS

For a more complete understanding of the present invention, the objects and advantages thereof, reference is now made to the following descriptions taken in connection with the accompanying drawings in which:

FIG. 1 depicts a system for near real time blockchain based payables versus receivables reconciliation according to an embodiment;

FIG. 2 depicts a method for near real time blockchain based payables versus receivables reconciliation according to an embodiment; and

FIG. 3 depicts an exemplary computing system for implementing aspects of the present disclosure.

### DETAILED DESCRIPTION OF PREFERRED EMBODIMENTS

Systems and methods for near real time blockchain based payables versus receivables reconciliation are disclosed.

Embodiments may match receivables with payables, and may reconcile the data in near real time. Embodiments may provide two nodes—one for receiving merchant data, and one for receiving payment brand data. For each transaction, a separate block may be generated, and data reconciliation may occur for each of the blocks.

Embodiments may provide visibility of matched data, unmatched data, and settlement amounts. Embodiments may also provide secure and untampered data movement amongst different engines using blockchain technology.

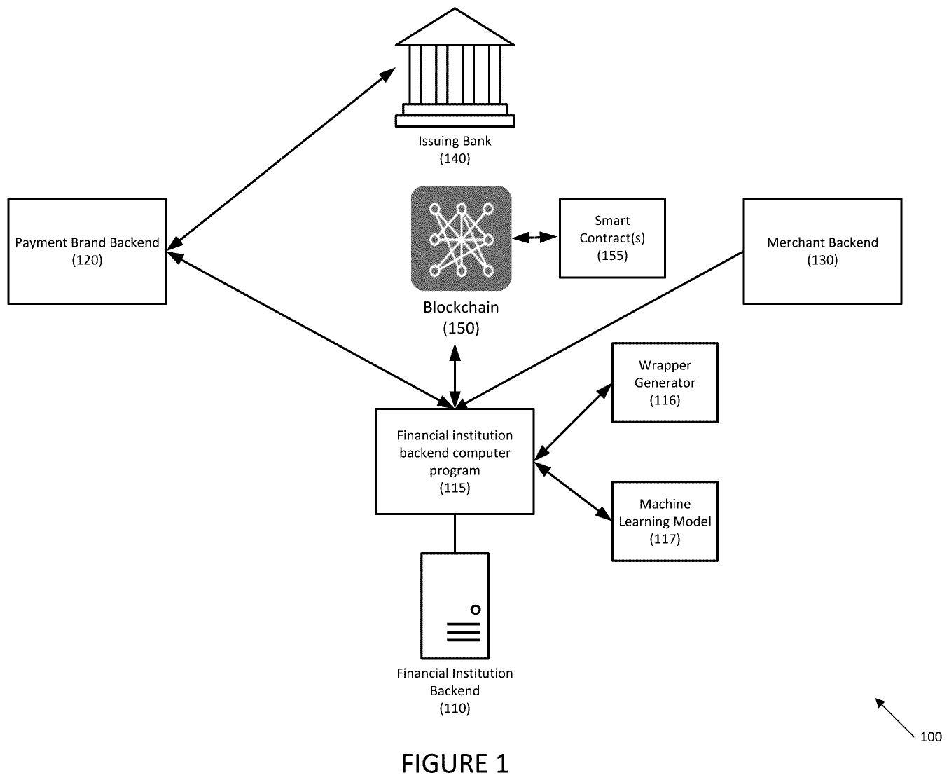

Referring to FIG. 1, a system for near real time blockchain based payables versus receivables reconciliation is disclosed according to an embodiment. System 100 may include financial institution backend 110, which may execute financial institution backend computer program 115. Financial institution backend computer program 115 may receive payables data from merchant backend 130 for a merchant. The merchant may be a type of merchant that provides goods or services to a customer.

Financial institution backend computer program 115 may write the payables data to blockchain 150.

Financial institution backend computer program 115 may communicate the payables data to payment brand backend 120 for a payment brand (e.g., Visa, MasterCard), such as a provider of a payment network.

Payment brand backend 120 may receive the payables data and may generate receivables data based on the payables data. Payment brand backend 120 may communicate the receivables data to financial institution backend computer program 115, which may write the receivables data to blockchain 150.

Payment brand backend 120 may interface with issuing bank 140, which may be the bank that issued the financial instrument that is involved in the transaction. Issuing bank 140 may verify receivables data provided by payment brand backend 120.

In one embodiment, the financial institution that provides financial institution backend computer program 115 and issuing bank 140 may be the same entity.

One or more smart contract 155 may automatically reconcile the payables data and the receivables data, and may generate a report of reconciled transactions and unreconciled transactions. In one embodiment, smart contract(s) 155 may determine the root cause for any unreconciled transactions and may automatically resolve any exceptions.

Financial institution backend computer program 115 may be provided with wrapper generator 116, which may be a computer program that may reformat payables data and/or receivables data for blockchain 150.

Financial institution backend computer program 115 may also be provided with machine learning model 117, which may be trained with historical data to predict automated actions for unreconciled transactions.

In another embodiment, financial institution backend 110, payment brand backend 120, and merchant backend 130 may all participate as nodes in a distributed ledger network (not shown), in which financial institution backend 110, payment brand backend 120, and merchant backend 130 may submit respective data to a local copy of a distributed ledger, such as blockchain 150.

In one embodiment, issuing bank 140 may also participate in the distributed ledger network.

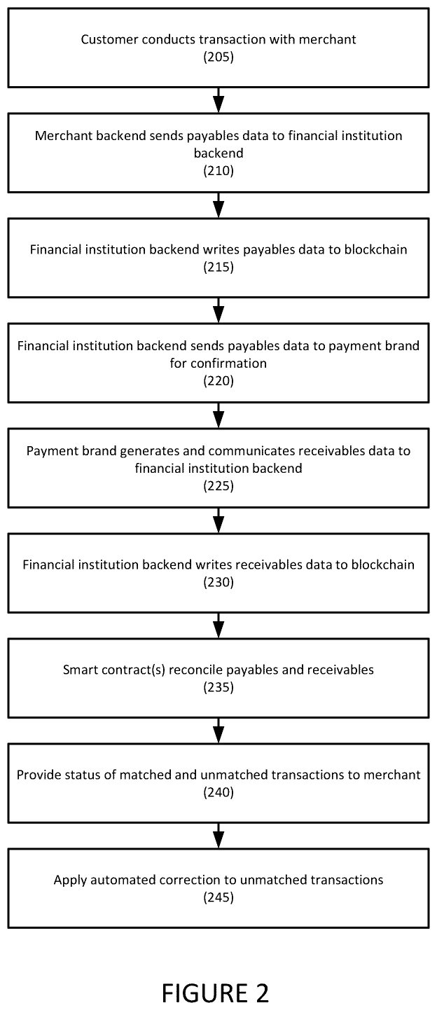

Referring to FIG. 2, a method for near real time blockchain based payables versus receivables reconciliation is disclosed according to an embodiment.

In step 205, a customer may conduct a transaction with merchant, such as a provider of a good or service. The transaction may be authorized as is customary.

In step 210, the merchant backend may send payables data to a financial institution backend. In one embodiment, the payables data may be sent for each transaction, periodically, in batches (e.g., semi-hourly, hourly, semi-daily, daily, or as otherwise necessary and/or desired). The payables data may include a merchant identifier, a transaction identifier, a payable transaction amount, a payable currency, a payable legal entity, payable a transaction type and region, etc.

In step 215, the financial institution backend may write the payables data to a blockchain. In one embodiment, the payables data for each transaction may be written as a block. In another embodiment, payables data for a group of transactions may be written as a block. In one embodiment, transactions may be grouped together as a block based on, for example, the payable accounting legal entity, the payable date and payment brand associated with the transaction.

In one embodiment, the financial institution backend may reformat the payables data using a wrapper computer program before writing the payables data to the blockchain.

In an alternate embodiment, the merchant backend may write the payables data to its copy of a distributed ledger.

In step 220, the financial institution backend may send the payables data to payment brand for confirmation. In one embodiment, the financial institution backend may send the payables data in an agreed-upon format.

In one embodiment, there may be an agreement in place between each payment brand and financial institution that may specify the standard format.

In one embodiment, if not already in the agreed-upon format, the financial institution computer program may use the wrapper computer program to re-format the payables data to the agreed-upon format. The payment brand may share the format in which they want the financial institution to send data. Unless there is a change, this agreed upon format remains constant.

In step 225, after receiving the payables data, the payment brand may generate receivables data and may communicate the receivables data to financial institution backend. In one embodiment, the receivables data may include the transaction identifier, a receivable transaction amount, a receivable currency, a receivable accounting legal entity, a receivable transaction type and region, etc. The payment brand may send the payables data to the issuer bank for confirmation. Based upon the data received from the issuer bank, the payment brand may generate the receivables data.

In step 230, the financial institution backend may receive the receivables data and may write the receivables data to the blockchain. In one embodiment, the financial institution backend computer program may format the receivables data into a standard format for the blockchain using, for example, the wrapper computer program.

In an alternate embodiment, the payment brand may write the receivables data to its copy of the distributed ledger.

In step 235, one or more smart contract(s) may reconcile payables and receivables. In one embodiment, the smart contracts may monitor the blockchain as payables data and/or receivables data are received and may automatically reconcile the payables data and receivables data for each transaction using the transaction identifier.

The smart contract(s) may reconcile payables and receivables as written, periodically, on-demand, etc. For example, the smart contracts may use the transaction identifier, the payable and receivable amount, the payable and receivable currency, the payable and receivable legal entity, the payable and receivable transaction date, etc. to reconcile the payables and the receivables.

In step 240, the smart contract(s) may provide a status of matched and unmatched transactions to the merchant. In one embodiment, the status may be provided in a computer file.

In step 245, the smart contract(s) may apply automated correction to unmatched transactions. For example, smart contract(s) may identify the un-matched data based upon the payables and receivables received from respective entities where an equality check is made for the transaction amount, transaction quantity and merchant Identifier which are grouped based on, for example, accounting legal entity and region. The unmatched transactions may be stored in a data warehouse, and may be ingested into a machine learning engine. The machine learning engine may be trained with historical data and may be used to predict a corrective action to be taken for the unmatched transactions. For example, unmatched transactions may be sent to the payment brand for correction. The transaction may be stored in the system until an agreed upon a service level agreement, after which it is moved into the historical data. It may then be used for training.

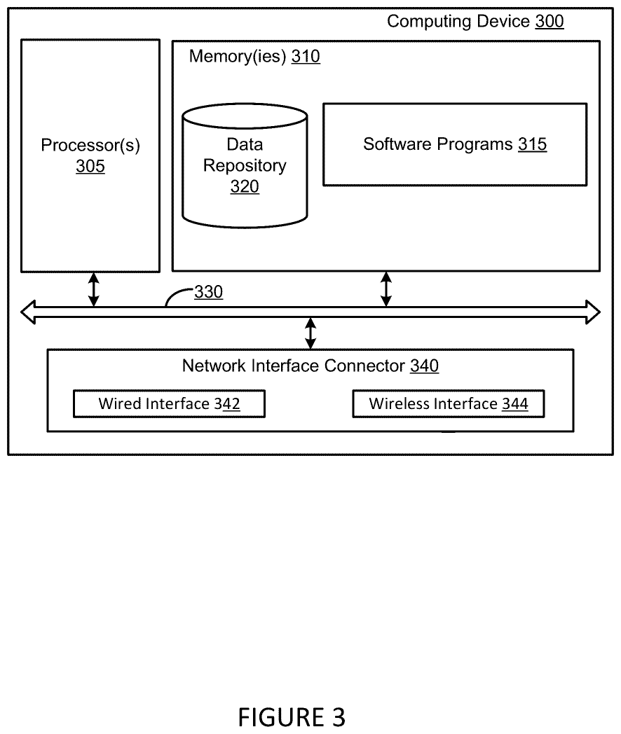

FIG. 3 depicts an exemplary computing system for implementing aspects of the present disclosure. FIG. 3 depicts exemplary computing device 300. Computing device 300 may represent the system components described herein. Computing device 300 may include processor 305 that may be coupled to memory 310. Memory 310 may include volatile memory. Processor 305 may execute computer-executable program code stored in memory 310, such as software programs 315. Software programs 315 may include one or more of the logical steps disclosed herein as a programmatic instruction, which may be executed by processor 305. Memory 310 may also include data repository 320, which may be nonvolatile memory for data persistence. Processor 305 and memory 310 may be coupled by bus 330. Bus 330 may also be coupled to one or more network interface connectors 340, such as wired network interface 342 or wireless network interface 344. Computing device 300 may also have user interface components, such as a screen for displaying graphical user interfaces and receiving input from the user, a mouse, a keyboard and/or other input/output components (not shown).

Hereinafter, general aspects of implementation of the systems and methods of embodiments will be described.

Embodiments of the system or portions of the system may be in the form of a “processing machine,” such as a general-purpose computer, for example. As used herein, the term “processing machine” is to be understood to include at least one processor that uses at least one memory. The at least one memory stores a set of instructions. The instructions may be either permanently or temporarily stored in the memory or memories of the processing machine. The processor executes the instructions that are stored in the memory or memories in order to process data. The set of instructions may include various instructions that perform a particular task or tasks, such as those tasks described above. Such a set of instructions for performing a particular task may be characterized as a program, software program, or simply software.

In one embodiment, the processing machine may be a specialized processor.

In one embodiment, the processing machine may be a cloud-based processing machine, a physical processing machine, or combinations thereof.

As noted above, the processing machine executes the instructions that are stored in the memory or memories to process data. This processing of data may be in response to commands by a user or users of the processing machine, in response to previous processing, in response to a request by another processing machine and/or any other input, for example.

As noted above, the processing machine used to implement embodiments may be a general-purpose computer. However, the processing machine described above may also utilize any of a wide variety of other technologies including a special purpose computer, a computer system including, for example, a microcomputer, mini-computer or mainframe, a programmed microprocessor, a micro-controller, a peripheral integrated circuit element, a CSIC (Customer Specific Integrated Circuit) or ASIC (Application Specific Integrated Circuit) or other integrated circuit, a logic circuit, a digital signal processor, a programmable logic device such as a FPGA (Field-Programmable Gate Array), PLD (Programmable Logic Device), PLA (Programmable Logic Array), or PAL (Programmable Array Logic), or any other device or arrangement of devices that is capable of implementing the steps of the processes disclosed herein.

The processing machine used to implement embodiments may utilize a suitable operating system.

It is appreciated that in order to practice the method of the embodiments as described above, it is not necessary that the processors and/or the memories of the processing machine be physically located in the same geographical place. That is, each of the processors and the memories used by the processing machine may be located in geographically distinct locations and connected so as to communicate in any suitable manner. Additionally, it is appreciated that each of the processor and/or the memory may be composed of different physical pieces of equipment. Accordingly, it is not necessary that the processor be one single piece of equipment in one location and that the memory be another single piece of equipment in another location. That is, it is contemplated that the processor may be two pieces of equipment in two different physical locations. The two distinct pieces of equipment may be connected in any suitable manner. Additionally, the memory may include two or more portions of memory in two or more physical locations.

To explain further, processing, as described above, is performed by various components and various memories. However, it is appreciated that the processing performed by two distinct components as described above, in accordance with a further embodiment, may be performed by a single component. Further, the processing performed by one distinct component as described above may be performed by two distinct components.

In a similar manner, the memory storage performed by two distinct memory portions as described above, in accordance with a further embodiment, may be performed by a single memory portion. Further, the memory storage performed by one distinct memory portion as described above may be performed by two memory portions.

Further, various technologies may be used to provide communication between the various processors and/or memories, as well as to allow the processors and/or the memories to communicate with any other entity; i.e., so as to obtain further instructions or to access and use remote memory stores, for example. Such technologies used to provide such communication might include a network, the Internet, Intranet, Extranet, a LAN, an Ethernet, wireless communication via cell tower or satellite, or any client server system that provides communication, for example. Such communications technologies may use any suitable protocol such as TCP/IP, UDP, or OSI, for example.

As described above, a set of instructions may be used in the processing of embodiments. The set of instructions may be in the form of a program or software. The software may be in the form of system software or application software, for example. The software might also be in the form of a collection of separate programs, a program module within a larger program, or a portion of a program module, for example. The software used might also include modular programming in the form of object-oriented programming. The software tells the processing machine what to do with the data being processed.

Further, it is appreciated that the instructions or set of instructions used in the implementation and operation of embodiments may be in a suitable form such that the processing machine may read the instructions. For example, the instructions that form a program may be in the form of a suitable programming language, which is converted to machine language or object code to allow the processor or processors to read the instructions. That is, written lines of programming code or source code, in a particular programming language, are converted to machine language using a compiler, assembler or interpreter. The machine language is binary coded machine instructions that are specific to a particular type of processing machine, i.e., to a particular type of computer, for example. The computer understands the machine language.

Any suitable programming language may be used in accordance with the various embodiments. Also, the instructions and/or data used in the practice of embodiments may utilize any compression or encryption technique or algorithm, as may be desired. An encryption module might be used to encrypt data. Further, files or other data may be decrypted using a suitable decryption module, for example.

As described above, the embodiments may illustratively be embodied in the form of a processing machine, including a computer or computer system, for example, that includes at least one memory. It is to be appreciated that the set of instructions, i.e., the software for example, that enables the computer operating system to perform the operations described above may be contained on any of a wide variety of media or medium, as desired. Further, the data that is processed by the set of instructions might also be contained on any of a wide variety of media or medium. That is, the particular medium, i.e., the memory in the processing machine, utilized to hold the set of instructions and/or the data used in embodiments may take on any of a variety of physical forms or transmissions, for example. Illustratively, the medium may be in the form of a compact disc, a DVD, an integrated circuit, a hard disk, a floppy disk, an optical disc, a magnetic tape, a RAM, a ROM, a PROM, an EPROM, a wire, a cable, a fiber, a communications channel, a satellite transmission, a memory card, a SIM card, or other remote transmission, as well as any other medium or source of data that may be read by the processors.

Further, the memory or memories used in the processing machine that implements embodiments may be in any of a wide variety of forms to allow the memory to hold instructions, data, or other information, as is desired. Thus, the memory might be in the form of a database to hold data. The database might use any desired arrangement of files such as a flat file arrangement or a relational database arrangement, for example.

In the systems and methods, a variety of “user interfaces” may be utilized to allow a user to interface with the processing machine or machines that are used to implement embodiments. As used herein, a user interface includes any hardware, software, or combination of hardware and software used by the processing machine that allows a user to interact with the processing machine. A user interface may be in the form of a dialogue screen for example. A user interface may also include any of a mouse, touch screen, keyboard, keypad, voice reader, voice recognizer, dialogue screen, menu box, list, checkbox, toggle switch, a pushbutton or any other device that allows a user to receive information regarding the operation of the processing machine as it processes a set of instructions and/or provides the processing machine with information. Accordingly, the user interface is any device that provides communication between a user and a processing machine. The information provided by the user to the processing machine through the user interface may be in the form of a command, a selection of data, or some other input, for example.

As discussed above, a user interface is utilized by the processing machine that performs a set of instructions such that the processing machine processes data for a user. The user interface is typically used by the processing machine for interacting with a user either to convey information or receive information from the user. However, it should be appreciated that in accordance with some embodiments of the system and method, it is not necessary that a human user actually interact with a user interface used by the processing machine. Rather, it is also contemplated that the user interface might interact, i.e., convey and receive information, with another processing machine, rather than a human user. Accordingly, the other processing machine might be characterized as a user. Further, it is contemplated that a user interface utilized in the system and method may interact partially with another processing machine or processing machines, while also interacting partially with a human user.

It will be readily understood by those persons skilled in the art that embodiments are susceptible to broad utility and application. Many embodiments and adaptations of the present invention other than those herein described, as well as many variations, modifications and equivalent arrangements, will be apparent from or reasonably suggested by the foregoing description thereof, without departing from the substance or scope.

Accordingly, while the embodiments of the present invention have been described here in detail in relation to its exemplary embodiments, it is to be understood that this disclosure is only illustrative and exemplary of the present invention and is made to provide an enabling disclosure of the invention. Accordingly, the foregoing disclosure is not intended to be construed or to limit the present invention or otherwise to exclude any other such embodiments, adaptations, variations, modifications or equivalent arrangements.

What is claimed is:

1. A method, comprising:
receiving, at a computer program executed by a financial institution backend, payables data for a plurality of transactions from a merchant, wherein each of the plurality of transactions in the payables data comprises a transaction identifier, a merchant identifier, a payable transaction amount, and a payables currency;
writing, by the computer program, the payables data to a blockchain;
sending, by the computer program, the payables data to a payment brand, wherein a payment brand computer program is configured to generate receivables data for the plurality of transactions, and the receivables data for each of the plurality of transactions comprises the transaction identifier, a receivable transaction amount, and a receivable currency;
receiving, by the computer program, the receivables data; and
writing, by the computer program, the receivables data to a blockchain, wherein a smart contract on the blockchain is configured to reconcile the transactions in the payables data with the transactions in the receivables data.

2. The method of claim 1, further comprising:
reformatting, by the computer program, the payables data before writing the payables data to the blockchain.

3. The method of claim 1, wherein the computer program writes the payables data to the blockchain as groups of transactions based on the payment brand associated with the transaction.

4. The method of claim 1, wherein the computer program sends the payables data to the payment brand in an agreed-upon format.

5. The method of claim 1, wherein the payment brand is configured to send the payables data to an issuer bank for confirmation.

6. The method of claim 1, further comprising:
reformatting, by the computer program, the receivables data before writing the receivables data to the blockchain.

7. The method of claim 1, wherein the smart contract is configured to monitor the blockchain for the payables data and the receivables data.

8. The method of claim 1, wherein the smart contract is configured to identify unmatched transactions.

9. The method of claim 8, wherein the unmatched transactions are ingested into a machine learning engine that predicts a corrective action for the unmatched transactions.

10. The method of claim 9, wherein the corrective action comprises sending the unmatched transactions to the payment brand for correction.

11. The method of claim 9, wherein the machine learning engine is trained with historical transaction data and historical corrective actions.

12. The method of claim 11, wherein the machine learning engine is further trained with the corrective actions for the unmatched transactions.

13. The method of claim 1, wherein the smart contract is configured to provide a status of matched and unmatched transactions to the merchant.
